(19) United States
(12) Patent Application Publication
(10) Pub. No.: US 2009/0055323 A1
(43) Pub. Date: Feb. 26, 2009

(54) System and method for providing custom personal identification numbers at point of sale

(75) Inventors: Matt Rebidue, Columbus, GA (US); Pat Weems, Eatonton, GA (US); JoAnn James, Columbus, GA (US); Donnis Jones, Columbus, GA (US); Brooke Gates, Columbus, GA (US)

Correspondence Address: KING & SPALDING LLP, 1180 PEACHTREE STREET, ATLANTA, GA, 30309-3521, US

(73) Assignee: Total System Services, Inc.

(21) Appl. No.: 11/894,896

(22) Filed: Aug. 22, 2007

(51) Int. Cl. G06Q 30/00

(52) U.S. Cl. 705/66; 235/380; 705/41

(57) ABSTRACT

Allowing an account holder for a newly-established financial card account to establish a PIN at the time the financial card account is opened and use that PIN to authenticate transactions at the time the account is opened. The systems and methods may include a POS device that securely captures and encrypts a custom PIN, that is, a PIN supplied by the customer for a new financial card account. The systems and methods would also include a transaction processing system that receives an encrypted PIN, along with customer information about a new financial card account, and processes that information and encrypted PIN to establish a new account. As a result of this processing, an authorization platform would receive information necessary to authenticate a user and authorize a transaction. Through these systems and methods, a customer would be able to use the custom PIN to authenticate a transaction at the time the new account is opened.

### FIELD OF THE INVENTION

This invention relates to systems and methods for providing a personal identification number (PIN) for a financial card account. More particularly, this invention relates to processes and systems that allow a customer to establish a custom PIN for a financial card account when applying for the account.

### BACKGROUND OF THE INVENTION

The use of financial cards for conducting financial transactions is ubiquitous. Two principal types of financial cards used to purchase goods or services are credit cards and debit cards. Typically, a credit card represents a line of credit that has been issued from a financial institution to an individual, the account holder. The credit card allows the account holder to purchase goods and services against the line of credit. The line of credit is associated with an account and that account has certain terms governing how credit is extended to the account holder. Typical terms include an annual interest rate charged on the amount of money actually lent to the account holder, a grace period that allows the account holder to pay for purchases without incurring interest charges, annual fees for the account, and other fees, such a late payment fees. Credit cards may be issued by national card associations, such as AMERICAN EXPRESS or DISCOVER CARD; a financial institution in conjunction with a national card association, such as a Bank of America VISA or MASTERCARD; or directly from a retailer, such as MACY'S or BRITISH PETROLEUM.

In contrast, a debit card, sometimes referred to as a check card, allows the cardholder to withdraw funds from the cardholder's bank account. Instead of making a purchase on credit, as with a credit card, the purchase is made with funds that the cardholder actually has on hand. Generally, a debit card is issued from the financial institution that maintains the financial account containing the funds used for the purchases, but not necessarily. For example, a merchant may issue a debit card to be used for purchases at that merchant's stores. Instead of drawing from a line of credit to satisfy a purchase of goods or services, which may be repaid through periodic payments, transactions are satisfied by transferring funds from a specific financial account to the merchant.

Often, financial card transactions require an account holder to enter a personal identification number (PIN) to complete the transaction. A PIN provides an added layer of security for purchases by preventing an unauthorized user from accessing the financial card account. An account holder, that is, a person authorized to use the financial card account, would enter the PIN into a point-of-sale (POS) device as part of an authorization process for the transaction.

PINs are typically a string of four numbers. PINs may be assigned by the financial card issuer but are often selected by the account holder. Typically, an account holder would specify a PIN when they apply for the financial card account by writing the PIN down or by telling a representative of the financial institution what the PIN is to be. Some time later, the account holder would receive their card in the mail. In a separate mailing, a PIN would be sent. The account holder would then use the card for transactions.

Some merchants allow a customer to “instantly” open a new account. However, for accounts that use a PIN in the purchase authorization process, a customer cannot create a PIN when they open up the account and then use that PIN in the payment process at the time the account is opened. Although the customer may be able to “instantly” establish a PIN, that customer cannot use that PIN to authenticate a transaction at that time—the PIN is not “instantly” sent to an authorization platform.

These typical processes prevent a customer from applying for a financial card at a merchant's facility or other financial facility and using the account, with a custom PIN, at that time, at least not where the PIN is used to authenticate the account holder. What is needed are systems and methods that allow an account holder for a newly-established financial card account to establish a PIN at the time the financial card account is opened and use that PIN in support of transaction at that time. That is, the PIN would be used to authenticate the user once the account is open, even for transactions that occur at the time the account is opened.

### SUMMARY OF THE INVENTION

The present invention supports systems and methods that allow a cardholder for a newly-established financial card account to establish a personal identification number (PIN) at the time the financial card account is opened. One aspect of the present invention provides a method for providing a custom personal identification number for a financial card account at a point of sale. This method includes the steps of: (a) receiving a personal identification number at a point of sale device, wherein the personal identification number is received in response to opening the financial card account; (b) associating the personal identification number with a dummy account number; (c) encrypting the personal identification number using the dummy account number; and (d) processing the encrypted personal identification number and dummy account number; wherein the processing allows the personal identification number to be operable in real time to authenticate transactions for the financial card account.

Another aspect of the present invention provides a method for processing a custom personal identification number as part of opening a financial card account. This method includes the steps of: (a) receiving an encrypted personal identification number and a dummy account number; (b) assigning an actual account number to the financial card account; (c) decrypting the encrypted personal identification number using the dummy account number; (d) calculating a personal identification number offset based on the personal identification number and the actual account number; and (e) providing the actual account number and the personal identification number offset to a transaction authorization platform, wherein the personal identification number can be used to authenticate transactions for the financial card account instantaneously after the personal identification number is supplied by a financial card account holder.

Yet another aspect of the present invention provides a method for providing a custom personal identification number for a financial card account at a point of sale. This method includes the steps of: (a) receiving a personal identification number at a point of sale device, wherein the personal identification number is received in response to opening the financial card account; (b) associating the personal identification number with a dummy account number; (c) encrypting the personal identification number using the dummy account number; (d) receiving an encrypted personal identification number and a dummy account number; (d) assigning an actual account number to the financial card account; (e) decrypting the encrypted personal identification number using the dummy account number; (f) calculating a personal identification number offset based on the personal identification number and the actual account number; and (g) providing the actual account number and the personal identification number offset to a transaction authorization platform, wherein the personal identification number can be used to authenticate transactions for the financial card account instantaneously after the personal identification number is supplied by a financial card account holder.

Yet another aspect of the present invention provides a system for providing a custom personal identification number for a financial card account at a point of sale. The system includes: a point of sale device module operable to receive a personal identification number and generate a dummy account number in response to receiving the personal identification number and further operable to encrypt the personal identification number using the dummy account number; and a transaction processing system, logically connected to the point of sale device module and operable to receive an encrypted personal identification number and associated dummy account number and further operable to decrypt the encrypted personal identification number and calculate a personal identification number offset and associate the personal identification number offset with an actual account number, whereby the personal identification number offset with an actual account number is used to authenticate transactions for the financial card account instantaneously after the personal identification number is supplied by a financial card account holder to the point of sale device module.

Yet another aspect of the present invention provides a method for providing a custom personal identification number for a financial card account at a point of sale. This method includes the steps of: (a) receiving a personal identification number at a point of sale device, wherein the personal identification number is received in response to opening the financial card account; (b) associating the personal identification number with an account number; (c) encrypting the personal identification number using the account number; and (d) processing the encrypted personal identification number and account number; wherein the processing allows the personal identification number to be operable in real time to authenticate transactions for the financial card account.

### BRIEF DESCRIPTION OF THE DRAWINGS

FIG. 1 depicts an operating environment in accordance with an exemplary embodiment of the present invention.

FIG. 2 depicts a system architecture in accordance with an exemplary embodiment of the present invention.

FIG. 3 depicts a process flow diagram for providing a custom personal identification number (PIN) for a customer opening a financial card account in accordance with an exemplary embodiment of the present invention.

FIG. 4 depicts a process flow diagram for establishing customer information for a customer opening a financial card account in accordance with an exemplary embodiment of the present invention.

FIG. 5 depicts a process flow diagram for processing a PIN request in accordance with an exemplary embodiment of the present invention.

FIG. 6 depicts a process flow diagram for processing a new financial card account in accordance with an exemplary embodiment of the present invention.

### DETAILED DESCRIPTION OF THE EXEMPLARY EMBODIMENTS

Exemplary embodiments of the present invention are provided. These embodiments include systems and methods that allow an account holder for a newly-established financial card account to establish a personal identification number (PIN) at the time the financial card account is opened and the use that PIN to authenticate transactions at that time. The systems and methods may include a point-of-sale (POS) device that securely captures and encrypts a custom PIN, that is, a PIN supplied by the customer for a new financial card account. The systems and methods would also include a transaction processing system that receives an encrypted PIN, along with customer information about a new financial card account, and processes that information and encrypted PIN to establish a new account. As a result of this processing, an authorization platform would receive information necessary to authenticate a user and authorize a transaction. Through these systems and methods, a customer would be able to use the custom PIN to authenticate a transaction at the time the new account is opened.

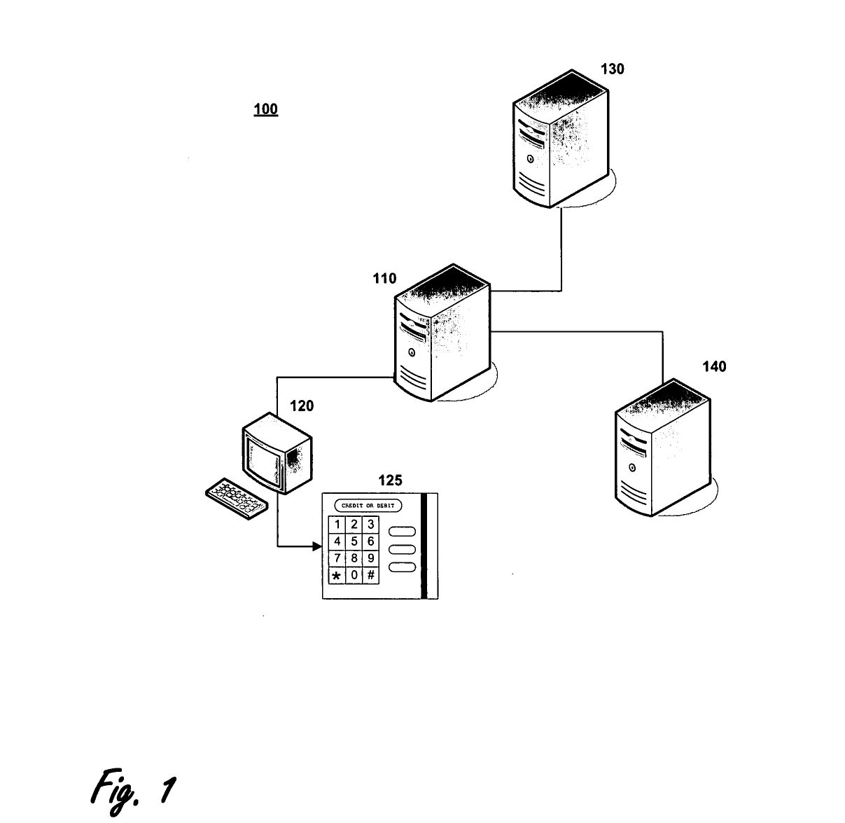

FIG. 1 depicts an operating environment 100 in accordance with an exemplary embodiment of the present invention. Referring to FIG. 1, the environment 100 includes a merchant's financial account system 110. This financial account system 110 may record purchases made by a customer that has a financial account with the merchant and coordinate the reconciliation of that account. The financial account system 110 may perform all tasks necessary for creating and maintaining the financial accounts, such as confirming customers' credit and approving applications for financial accounts, recording purchases and credits, billing customers for account balances, and processing payments. Alternatively, one or more of these functions may be performed by a third party as a service to the merchant. For example, a customer's credit information, typically checked during the process where the customer applies for a financial account, may be gathered by a third party vendor, such as a credit bureau 130. Also, a vendor may provide authorization services on an authorization platform, where each purchase of goods or services is approved by that vendor for the merchant. This vendor, such as transaction processing platform 140, may also support other activities associated with opening a financial account. One of ordinary skill in the art would appreciate that all functions of the financial account system may be performed by one or more third-party vendors.

Merchants typically use POS devices to capture financial card transaction information, such as terminal 120 with card reader 125. For example, a cardholder that has a financial card account with a merchant may go to one of the merchant's stores and purchase goods or services. When that account holder goes to pay for the goods or services, they would typically present a card. This card would have encoded information, either on a magnetic stripe, an embedded chip (such as on a “smart card”, or a radiofrequency identification (RFID) chip. The merchant's POS devices would read the encoded information at the time of purchase. In a typical process, the customer would swipe the magnetic stripe of the financial card using a card reader such as card reader 125. The card reader 125 would extract information from the card. The cardholder may also enter a PIN to complete the transaction.

When the account holder enters the PIN, the POS encrypts the PIN. The encrypted PIN is compared to information extracted from the magnetic stripe and manipulated with a standard encryption process. For example, the PIN verification system may generate a “natural PIN” from the cardholder's account number, using a known encryption process. The natural PIN would then be modified by an offset and that modified value compared to the account holder-supplied PIN. Often, the offset is a four-digit number that, when added to the natural PIN, equals the customer's chosen PIN. In this way, the financial institution need only have the numbers used to derive the natural PIN and the offset to verify a customer's PIN—the institution would not need to store the actual PIN.

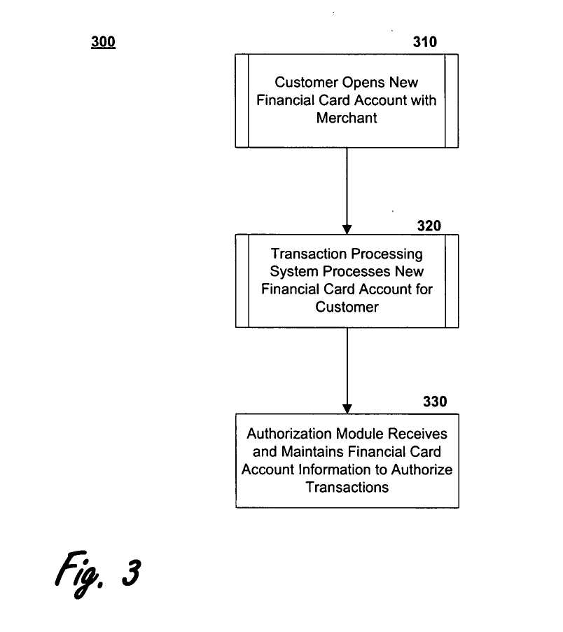

The operating environment 100 can be used to establish a custom PIN for an customer at the time the customer opens a financial card account with a merchant, such that the PIN is available “instantaneously” after the account is open, that is, the PIN can be used to authenticate a transaction immediately after the account is opened by the customer. This process is described in greater detail below, in connection with FIGS. 3-6.

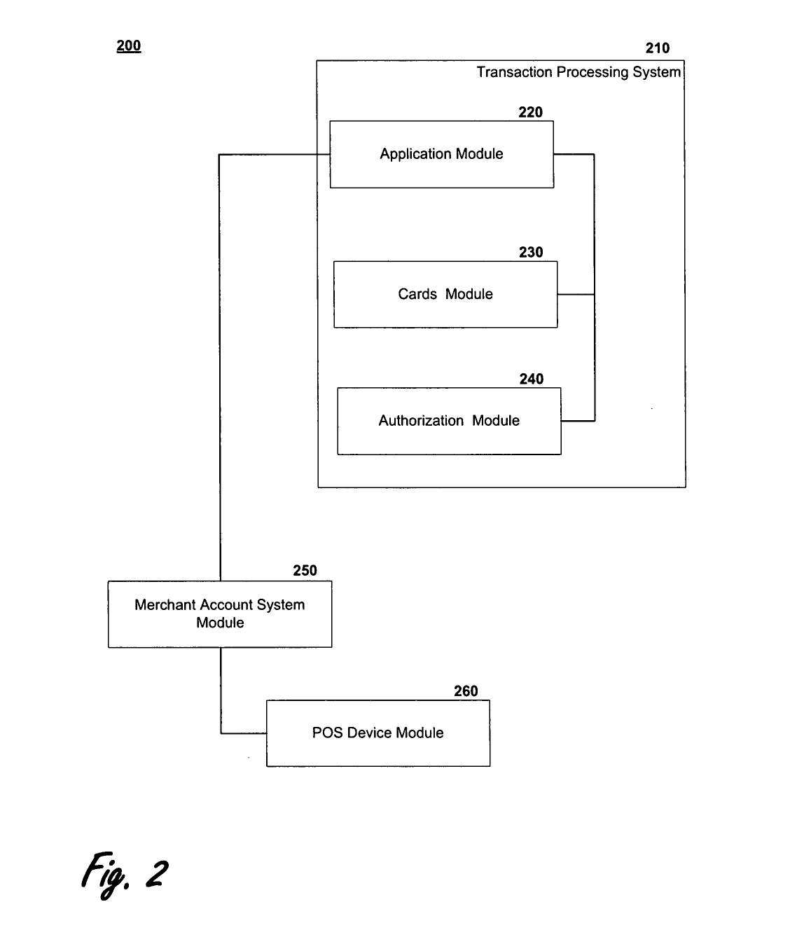

FIG. 2 depicts a system architecture 200 in accordance with an exemplary embodiment of the present invention. Referring to FIGS. 1 and 2, a transaction processing system 210 supports establishing a financial card account for a customer. The transaction processing system 210 may reside on the transaction processing platform 140.

An application module 220 supports establishing a new financial card account. The application module 220 receives customer information from the merchant account system module 250, which resides on the server 110. This customer information may include personal identifying information, such as name, address, and phone number; financial information, such as income and existing financial accounts; and credit information. The credit information may be supplied by the credit bureau 130. The credit bureau 130 may supply the credit information directly to the application module 220, either in response to instructions from the application module 220 or the merchant account system 250. The application module 220 assigns an account number to the new financial account. The application module 220 may also establish other account criteria, such as a credit limit. The credit limit may be based on policies established by the merchant. For example, a certain income level or credit rating may translate into a certain credit limit. Alternatively, the merchant may transmit the account criteria along with the customer information to the application module 220.

The application module 220 interacts with a cards module 230. The cards module 230 includes cryptographic functions. For example, the cards module 230 decrypts an encrypted PIN for a new financial card account sent to the transaction processing system 210 by the merchant account system 250. The cards module 230 also calculates an offset for the account.

Often, PINs for financial card accounts are calculated by taking the last five significant digits of the financial card account number and adding a prefix of validation data, often eleven numerical digits. These numbers may be the first eleven digits of the account number. One of ordinary skill in the art would understand that these validation numbers could also be a combination or a function of the card issue date, card expiration date, or other numerical data associated with the account. In any case, the resulting sixteen-digit value is used as input to an encryption algorithm. A common algorithm for encrypting financial account information is the Data Encryption Standard (DES) algorithm. The DES algorithm is used to “lock” the information at one point and “unlock” it at another. Keys are used to lock and unlock the information. A key is often a numerical value. The length of the key generally determines the relative security of the key. The information to be encrypted that is input into the algorithm is referred to as “plaintext” and the resulting encrypted information is “ciphertext.”

The DES algorithm takes the sixteen digit number and encrypts it using an encryption key, called the PIN key. The output from the DES algorithm is a string of numbers and letters. The first four alphanumeric characters of the result are decimalized (e.g., A=0, B=1, 1=1, 2=2), and the result is called the “natural PIN”.

A natural PIN represents a secure number that a financial institution or authorization platform can always determine, provided it knows the algorithm and key used to transform the input number into the “natural PIN.” However, this four-digit number is likely meaningless to a customer. As such, many financial institutions and merchants allow their customers choose their own PINs, or to change a PIN if it became known to somebody else. Because the chosen PIN would not be the natural PIN calculated with the encryption algorithm, a PIN offset is determined.

The application module 220 and the cards module 230 interact with an authorization module 240. The authorization module 240 authorizes specific financial card account transactions. The authorization process may include authenticating an account holder by verifying the PIN entered by the person initiating the transaction, such as a purchase of goods or services. The authorization module 240 may also verify that an available credit line or account balance is sufficient to cover a purchase. The authorization module 240 may also support reconciling the transaction. The authorization module 240 may be part of an authorization platform, which authorizes financial card transactions.

The merchant account system module 250 is connected to a POS device module 260, which resides on the terminal 120 with card reader 125. The POS device module 260 captures a PIN entered by a customer and encrypts that PIN. The POS device module 260 may include a hardware security module (not shown). The hardware security module may be integral to a single POS device module 260 for each separate POS device or multiple POS devices may share a single, server-based hardware security module. The hardware security module allows for the secure storage and encryption of information. The hardware security module prevents unauthorized access to a PIN during this process.

The transaction processing system 210 may also support generating a physical card for the customer to use or may interact with a third-party vendor, such as a card personalization bureau (not shown), that produces the physical cards. Alternatively, the financial card account may not be represented by a physical card. For example, the customer may supply their name to the merchant and then be asked to enter a PIN to verify authorized access to an account.

One of ordinary skill in the art would understand that the transaction processing system 210 may reside on a single server or set of servers at a single organization or may be distributed among a variety of organizations. For example, the authorization module 240 may reside on an authorization platform (not shown) resident at a vendor that supplies financial transaction authorization services. In another example, the merchant account system 250 may reside at a third party vendor that provides account application and management services.

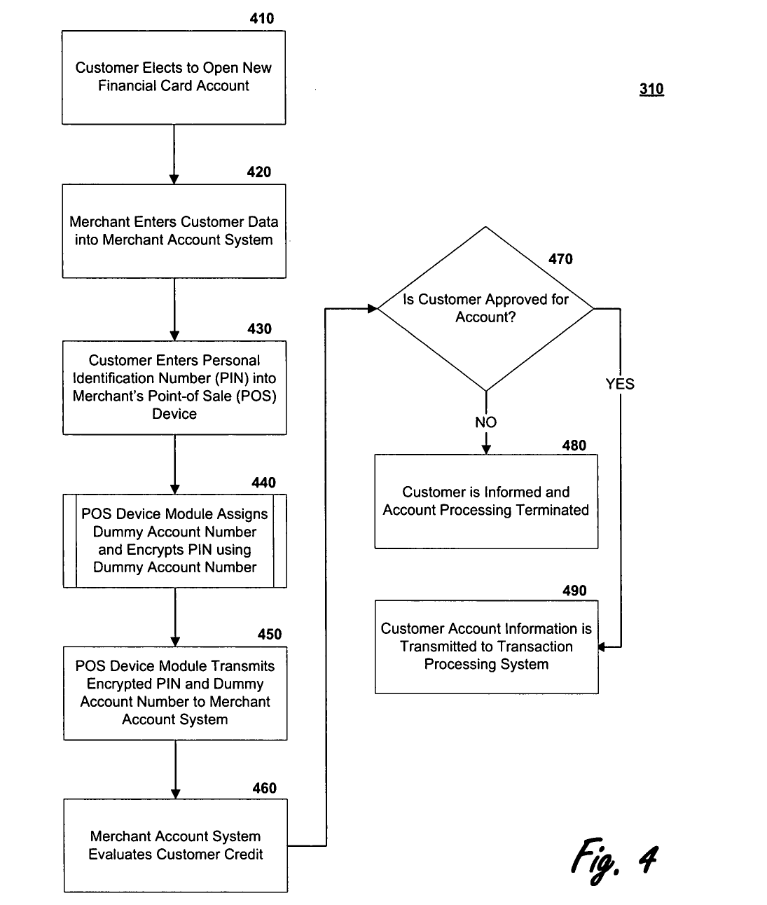

FIG. 3 depicts a process flow diagram 300 for providing a custom PIN for a customer opening a financial card account in accordance with an exemplary embodiment of the present invention. Referring to FIGS. 2 and 3, at step 310, a customer opens a new financial card account with a merchant, such as a merchant with a merchant account system 250. This step is discussed in greater detail below, in connection with FIG. 4.

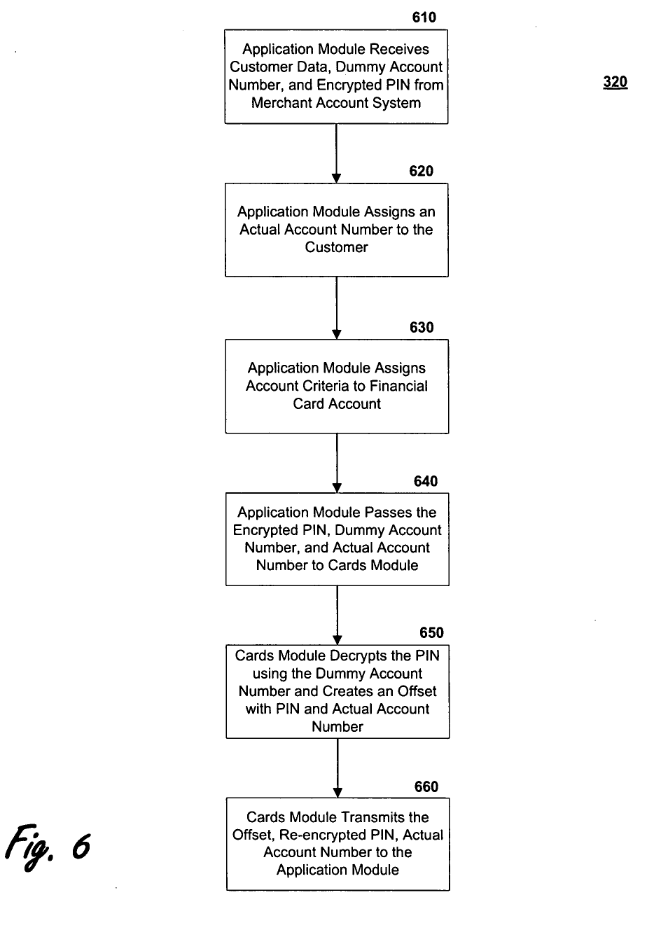

At step 320, the transaction processing system 210 processes the new financial card account for the customer. This step is discussed in greater detail below, in connection with FIG. 6. At step 330, the authorization module 240 receives and maintains financial card account information. This information, which may include a PIN offset, account number, and account criteria such as credit limit, is used to authorize individual financial transactions for the financial card account.

FIG. 4 depicts a process flow diagram 310 for establishing customer information for a customer opening a financial card account in accordance with an exemplary embodiment of the present invention. Referring to FIGS. 1, 2, and 4, at step 410 a customer elects to open a new financial card account. In this exemplary embodiment, the customer enters a merchant's store and responds to an offer to open a new account.

At step 420, the merchant collects information from a customer and enters the information into a merchant account system 250. This information may include name, address, phone number, social security number, driver's license number, and financial account numbers. At step 430, the customers enters a PIN into the merchant's POS device, such as terminal 120 with card reader 125. The customer would enter a four digit number onto the keypad of the card reader 125. This PIN would be a number that customers choose themselves, rather than a number supplied by the merchant. This custom PIN allows the customer to have a PIN that is more readily remembered and changed, if necessary.

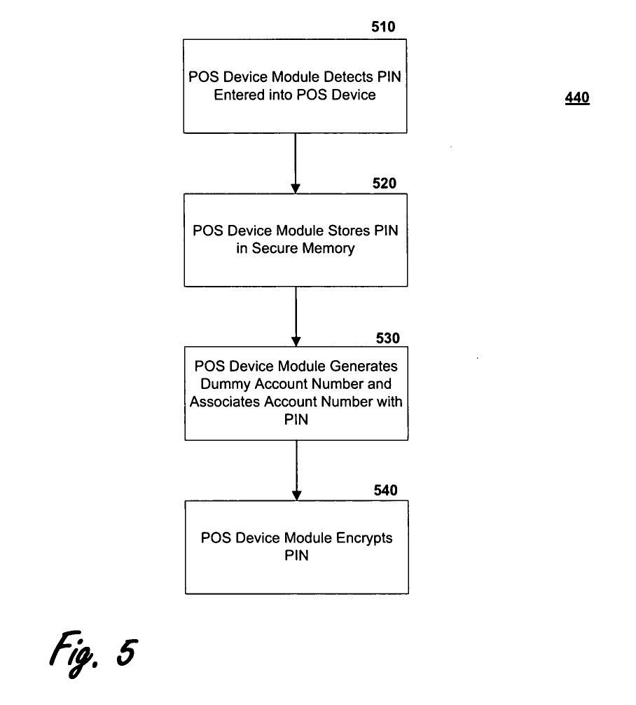

At step 440, the POS device module 260 assigns a dummy account number and encrypts the customer-supplied PIN using the dummy account number. This step is discussed in greater detail below, in connection with FIG. 5.

At step 450, the POS device module 260 transmits the encrypted PIN and dummy account number to the merchant account system 250. At step 460, the merchant account system 250 evaluates the customer's credit to determine if the new account should be approved. This step may include getting credit information from the credit bureau 130. At step 470, the process 310 determines if the customer's new account is approved.

If the result at step 470 is “NO,” at step 480 the customer is informed and the account processing is terminated. If the result at step 470 is “YES,” at step 490 the customer account information is transmitted by the merchant account system 250 to the transaction processing system 210 to end process 310. The transmitted information may include the customer data collected by the merchant, any collected credit data, and account criteria. The information also would include the encrypted PIN and dummy account number.

In an alternative embodiment, the encrypted PIN and dummy account may be sent to a third-party PIN processor. This third-party PIN processor may decrypt the encrypted PIN and re-encrypt the PIN using the dummy account but a different encryption key. The transaction processing system 210 would then use this encryption key to decrypt the PIN, as discussed below in connection with FIG. 6. For example, a PIN processor may have access to the encryption keys used by the POS device module 260 and by the transaction processing system 210, but the transaction processing system 210 does not have access to the encryption keys used by the POS device module 260. This situation may exist merely because of the shear number of keys involved. In this case, the PIN would be encrypted using the encryption key of the POS device module 260. The third-party PIN processor would decrypt the PIN using that same encryption key used by the POS device module 260. The PIN processor would then re-encrypt the PIN using an encryption key used by the transaction processing system 210. The transaction processing system 210 would then be able to decrypt the PIN with its own encryption key without needing to know each and every encryption key used by the POS device module 260.

The processing steps of process 310 would take place “instantaneously.” That is, the processing steps would take place while the customer was still in the store, rather than over a period of hours or days.

FIG. 5 depicts a process flow diagram 440 for processing a PIN request in accordance with an exemplary embodiment of the present invention. Referring to FIGS. 1, 2, and 5, at step 510 the POS device module 260 detects a customer entering a PIN. At step 520, the POS device module 260 securely stores the PIN in a hardware security module.

At step 530, in response to detecting the PIN, the POS device module 260 generates a dummy account number. The POS device module 260 generates the dummy account number randomly. One of ordinary skill in the art would understand that this “random” account number may include some fixed identifier numbers. These fixed numbers may include a POS device identifier, a time/date stamp, or other non-random information in addition to a random sequence of numbers. For example, the first 10 digits of a dummy account number may comprise a randomly-generated number, while the next two digits represent a POS device or store identifier and the last four numbers the hours and minutes, in military time.

This dummy account is a single-use number that is used to encrypt the custom PIN. A dummy account number is used since an actual account number would not be determined by the POS device. The actual account number is assigned by the transaction processing system 210, based on a range of numbers available to the card issuer. One of ordinary skill in the art would appreciate that the actual account number may be used if the POS device could access the system that assigned these account numbers to the account holder.

At step 540, the POS device module encrypts the PIN. In this exemplary embodiment, the encryption algorithm is a triple DES algorithm, which uses three 64-bit encryption keys and uses both the customer-supplied PIN and the dummy account number as the “plaintext” input. This dummy account number is a single-use account number. It purpose is to provide a means for securely transmitting a customer-supplied PIN to the transaction processing system 210 and allowing the transaction processing system 210 to then decrypt the PIN.

FIG. 6 depicts a process flow diagram 320 for processing a new financial card account in accordance with an exemplary embodiment of the present invention. Referring to FIGS. 2 and 6, at step 610, the application module 220 receives customer information, including the encrypted PIN and dummy account number associated with the new financial card account. At step 620, the application module 220 assigns an actual account number to the new financial card account. That is, the account number that will be associated with the financial card account from that point in time on is assigned.

At step 630, the application module 220 assigns account criteria to the financial card account. These criteria may include a credit limit, velocity, or other limitations. These criteria may be developed by the application module 220, perhaps based on merchant-supplied policies and rules, or may be supplied directly by the merchant along with the customer information for the new account.

At step 640, the application module 220 passes the encrypted PIN, dummy account number, and actual account number to the cards module 230. At step 650, the cards module 230 decrypts the PIN using the dummy account number and the same encryption algorithm and keys used to encrypt the PIN. The cards module 230 then uses the actual account number and PIN to create a PIN offset. As discussed above, the account number is used to generate a “natural PIN” using an encryption algorithm and the PIN offset is the difference between the natural PIN and customer-supplied PIN.

At step 660, the cards module 230 re-encrypts the PIN and transmits the calculated PIN offset, the encrypted PIN, and the actual account number to the application module 220, ending process 320. As with process 310, process 320 occurs “instantaneously”—the processing steps would take place while the customer was still in the store, rather than over a period of hours or days. As a result, the customer can use the PIN that they developed for transactions at the store at the time the new financial card account is opened.

In this exemplary embodiment, if a new account is opened in connection with a purchase, such as when a customer goes to the checkout with a purchase, then this initial purchase does not go through the authorization process. However, if the customer makes a purchase after the account is opened but during the same store visit, such as by purchasing a second item before they leave the store, then the authorization process would be used for that purchase and, most significantly, the PIN would be used to authenticate the account holder. Similarly, if a customer enters a store, opens an account upon entering, then makes a purchase while still in the store, then the authorization process would be used for that purchase and, again, the PIN would be used to authenticate the account holder. This “instant” activation of a custom PIN is a unique feature to the present invention.

One of ordinary skill in the art would appreciate that the present invention supports systems and methods that allow an account holder for a newly-established financial card account to establish a PIN at the time the financial card account is opened and use that PIN to authenticate transactions at the time the account is opened. The systems and methods may include a POS device that securely captures and encrypts a custom PIN, that is, a PIN supplied by the customer for a new financial card account. The systems and methods would also include a transaction processing system that receives an encrypted PIN, along with customer information about a new financial card account, and processes that information and encrypted PIN to establish a new account. As a result of this processing, an authorization platform would receive information necessary to authenticate a user and authorize a transaction. Through these systems and methods, a customer would be able to use the custom PIN to authenticate a transaction at the time the new account is opened.

What is claimed:

1. A method for providing a custom personal identification number for a financial card account at a point of sale comprising the steps of:
receiving a personal identification number at a point of sale device, wherein the personal identification number is received in response to opening the financial card account;
associating the personal identification number with a dummy account number;
encrypting the personal identification number using the dummy account number; and
processing the encrypted personal identification number and dummy account number; wherein the processing allows the personal identification number to be operable in real time to authenticate transactions for the financial card account.

2. The method of claim 1 wherein the step of processing the encrypted personal identification number and dummy account number further comprises the steps of:
receiving the encrypted personal identification number and the dummy account number;
assigning an actual account number to the financial card account;
decrypting the encrypted personal identification number using the dummy account number;
calculating a personal identification number offset based on the personal identification number and the actual account number; and
providing the actual account number and the personal identification number offset to a transaction authorization platform, wherein the personal identification number can be used to authenticate transactions for the financial card account instantaneously after the account is opened.

3. The method of claim 1 wherein the step of encrypting the personal identification number using the dummy account number comprises employing a hardware security module to protect the security of the personal identification number.

4. The method of claim 1 wherein the financial card account comprises a debit card for a merchant.

5. The method of claim 1 further comprising the step of approving the financial card account.

6. A method for processing a custom personal identification number as part of opening a financial card account comprising the steps of:
receiving an encrypted personal identification number and a dummy account number;
assigning an actual account number to the financial card account;
decrypting the encrypted personal identification number using the dummy account number;
calculating a personal identification number offset based on the personal identification number and the actual account number; and
providing the actual account number and the personal identification number offset to a transaction authorization platform, wherein the personal identification number can be used to authenticate transactions for the financial card account instantaneously after the personal identification number is supplied by a financial card account holder.

7. The method of claim 6 wherein the personal identification number comprises a value provided at a point of sale to authenticate the financial card account holder.

8. The method of claim 7 wherein the personal identification number comprises a custom number supplied by the financial card account holder.

9. The method of claim 6 further comprising the step of receiving one or more data items comprising information about the financial card account holder.

10. A method for providing a custom personal identification number for a financial card account at a point of sale comprising the steps of:
receiving a personal identification number at a point of sale device, wherein the personal identification number is received in response to opening the financial card account;
associating the personal identification number with a dummy account number;
encrypting the personal identification number using the dummy account number;
receiving an encrypted personal identification number and a dummy account number;
assigning an actual account number to the financial card account;
decrypting the encrypted personal identification number using the dummy account number;
calculating a personal identification number offset based on the personal identification number and the actual account number; and
providing the actual account number and the personal identification number offset to a transaction authorization platform, wherein the personal identification number can be used to authenticate transactions for the financial card account instantaneously after the personal identification number is supplied by a financial card account holder.

11. The method of claim 10 wherein the step of encrypting the personal identification number using the dummy account number comprises employing a hardware security module to protect the security of the personal identification number.

12. The method of claim 10 wherein the financial card account comprises a debit card for a merchant.

13. The method of claim 10 further comprising the step of approving the financial card account.

14. A system for providing a custom personal identification number for a financial card account at a point of sale comprising:
a point of sale device module operable to receive a personal identification number and generate a dummy account number in response to receiving the personal identification number and further operable to encrypt the personal identification number using the dummy account number; and
a transaction processing system, logically connected to the point of sale device module and operable to receive an encrypted personal identification number and associated dummy account number and further operable to decrypt the encrypted personal identification number and calculate a personal identification number offset and associate the personal identification number offset with an actual account number, whereby the personal identification number offset with an actual account number is used to authenticate transactions for the financial card account instantaneously after the personal identification number is supplied by a financial card account holder to the point of sale device module.

15. The system of claim 14 further comprising a merchant account system module logically connected to the point of sale device module and the transaction processing system and operable to receive customer information and approve the opening of a financial card account.

16. The system of claim 14 further comprising an authorization module operable to maintain the personal identification number offset and associated actual account number and authorize purchases of goods and services using the financial card account, wherein the authorization comprises authenticating a personal identification number supplied by the purchaser.

17. A method for providing a custom personal identification number for a financial card account at a point of sale comprising the steps of:
receiving a personal identification number at a point of sale device, wherein the personal identification number is received in response to opening the financial card account;
associating the personal identification number with an account number;
encrypting the personal identification number using the account number; and
processing the encrypted personal identification number and account number; wherein the processing allows the personal identification number to be operable in real time to authenticate transactions for the financial card account.

18. The method of claim 17 wherein the step of processing the encrypted personal identification number and account number further comprises the steps of:
receiving the encrypted personal identification number and the account number;
decrypting the encrypted personal identification number using the account number;
calculating a personal identification number offset based on the personal identification number and the account number; and
providing the account number and the personal identification number offset to a transaction authorization platform, wherein the personal identification number can be used to authenticate transactions for the financial card account instantaneously after the account is opened.
